(19) United States
(12) Patent Application Publication
(10) Pub. No.: US 2006/0147114 A1
(43) Pub. Date: Jul. 6, 2006

(54) Image segmentation in time-series images

(76) Inventors: Michael Reinhold Kaus, Hamburg (DE); Vladimir Pekar, Hamburg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/560,636

(22) PCT Filed: Jun. 7, 2004
(86) PCT No.: PCT/IB04/50846

§ 371 Date: Dec. 13, 2005

(30) Foreign Application Priority Data
Jun. 12, 2003 (EP) 03101750.2

(51) Int. Cl. G06K 9/34

(52) U.S. Cl. 382/173

(57) ABSTRACT

The basic principle of deformable models consists of the adaptation of flexible surfaces, such as triangular meshes to structures in the image. The optimal adaptation of an initial mesh is solved by energy minimization, where maintaining the shape of a geometric model is traded off against detected feature points of the surface of the structure in the image. According to the present invention, a prior shape model M(t) is combined with adaptation results S(t−1) of a previous image. Advantageously, this provides for a robust segmentation of moving or deforming objects.

The present invention relates to the field of digital imaging. In particular, the present invention relates to a method of determining a first segmentation result of an object of interest in a first image of time-series images, to an image processing device and to a computer program for an image processing device.

Segmentation methods are used to derive geometric models of, for example, organs or bones or other objects of interest from volumetric image data, such as CT, MR or US images. Such geometric models are required for a variety of medical applications, or generally in the field of pattern recognition. For medical or clinical applications, an important example is cardiac diagnosis, where geometric models of the ventricles and the myocard of the heart are required, for example, for perfusion analysis, wall motion analysis and computation of the ejection fraction. Another important clinical application is radio-therapy planning (RTP), where the segmentation of multiple organs and bones, for example, in the prostate region, is necessary for the diagnosis and/or the determination of the treatment parameters.

Deformable models are a very general class of methods for the segmentation of structures in 3D images. Deformable models are known, for example, from an article of T. McInerney et al “Deformable models in medical image analysis: A survey” in Medical Image Analysis, 1 (2): 91-108 1996.

The basis principle of deformable models consists of the adaptation of flexible meshes, represented, for example, by triangles or simplexes, to the object of interest in an image. For this, the model is initially placed near or on the object of interest in the image. This may be done by a user. Then, coordinates of surface elements of the flexible mesh, such as triangles, are iteratively changed until they lie on or close to the surface of the object of interest. Such a method is described in further detail in J. Weese et al “Shape constrained deformable models for 3D medical image segmentation” in 17^{th} International Conference on Information Processing in Medical Imaging (IPMI), pages 380 to 387, Davies, Calif., USA, 2001, Springer Verlag.

The optimal adaptation of an initial mesh is found by energy minimization, where maintaining the shape of a geometric model is traded off against detected feature points of the object surface in the image. Feature point detection may be carried out locally for each triangle or simplex by searching for possible object surfaces in the image, for example, along a normal of the triangle or simplex.

Segmenting moving and/or deforming objects, such as, for example, the lung, the bladder or the heart from a time-series of 3D images is difficult in the case of significant surface changes of the object. Because deformable models are local methods, their capture range may be too small, resulting in segmentation errors.

It is an object of the present invention to provide for an improved segmentation of moving or deforming objects from time-series of images.

According to an aspect of the present invention, the above object may be solved by a method of determining a first segmentation result of an object of interest in a first image of time-series images, in accordance with claim 1. The time-series images include first and second images. According to an aspect of the present invention, an adaptation of an initial mesh to the object of interest in the first image is performed to determine the first segmentation result. The adaptation is performed on the basis of an energy optimization using the initial mesh and a shape model of the first image. The initial mesh corresponds to a second segmentation result of the object of interest in the second image, which precedes the first image in the time-series images.

Advantageously, according to an aspect of the present invention, a prior 4D shape model is combined with the adaptation results of a previous image. Due to this, a method is provided which allows to automatically model and segment structures that move and deform over time. Furthermore, advantageously, the present invention may allow to increase a robustness of the deformable model segmentation for 4D applications. Furthermore, the method according to this exemplary embodiment of the present invention may allow to predict a next time step based on the model and the previous adaptation result.

According to another exemplary embodiment of the present invention as set forth in claim 2, an internal energy corresponding to a first distance between the first segmentation result and the shape model and an internal energy corresponding to a second distance between the object of interest and the first segmentation result are determined, which are minimized. This allows for a fast and robust segmentation.

Claims 3 to 6 provide for further advantageous exemplary embodiments of the present invention.

According to another exemplary embodiment of the present invention as set forth in claim 7, an image processing device is provided suitably adapted for executing the method according to the present invention. Advantageously, this image processing device allows a very accurate and robust segmentation of moving and/or deforming objects in time-series images, where a failure may be avoided in case a change from one image to the next image is too large. Furthermore, improved segmentation results may be provided, since segmentation results from preceding images are incorporated in the determination of segmentation results in the actual image.

According to another exemplary embodiment of the present invention, a computer program is provided allowing for an improved segmentation of moving or deforming objects in time-series images. The computer program may be written in any suitable programming language, such as C++ and may be stored on a computer readable device, such as a CD-ROM. However, the computer program according to the present invention may also be presented over a network such as the WorldWideWeb, from which it may be downloaded.

It may be seen as the gist of an exemplary embodiment of the present invention that a prior 4D shaped model is combined with adaptation results of a previous image of the time-series images. According to an aspect of the present invention, the adaptation or segmentation result S(T) of the preceding image, is used as the initial mesh for the image I(T+1). For the adaptation, the model M(T+1) of the image I(T+1) is used as the corresponding shape model. In that way, the general a prior time varying shape model and the patient-specific image data (i.e. the previous images of the time sequences) are taken into account.

These and other aspects of the present invention will become apparent from and elucidated with reference to the embodiments described hereinafter.

Exemplary embodiments of the present invention will be described in the following, with reference to the following drawings:

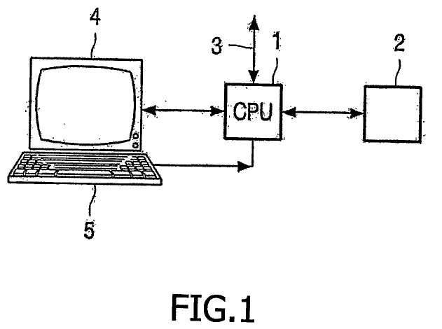

FIG. 1 shows a schematic representation of an image processing device according to an exemplary embodiment of the present invention, adapted to execute a method according to an exemplary embodiment of the present invention.

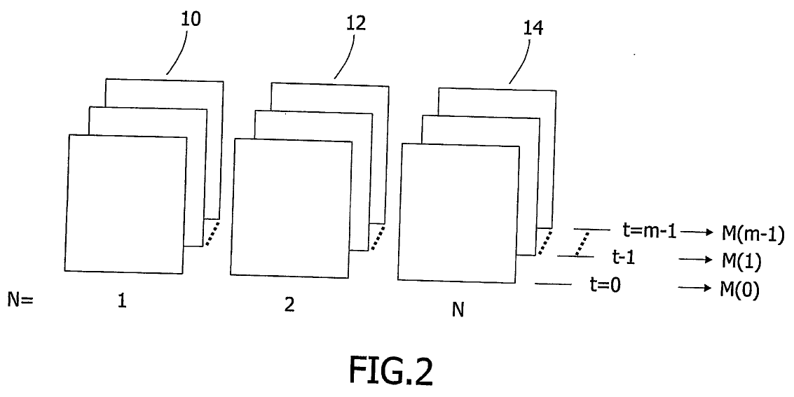

FIG. 2 shows a simplified representation for further explaining the generation of a surface model, which may be applied in the method according to the present invention.

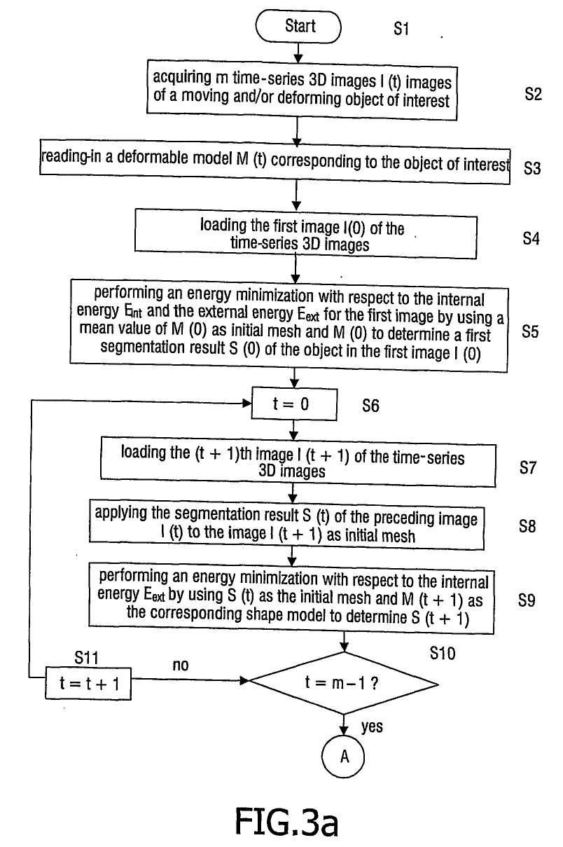

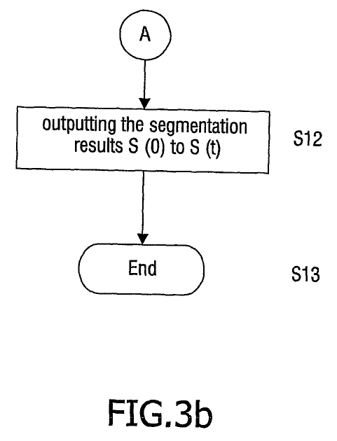

FIGS. 3a and 3b show a flowchart of an exemplary embodiment of a method for operating the image processing device of FIG. 1 according to the present invention.

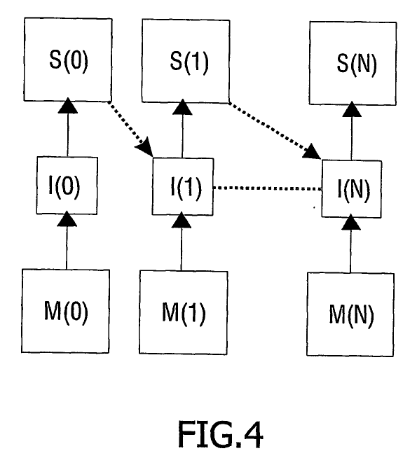

FIG. 4 shows a simplified representation for further explaining the present invention.

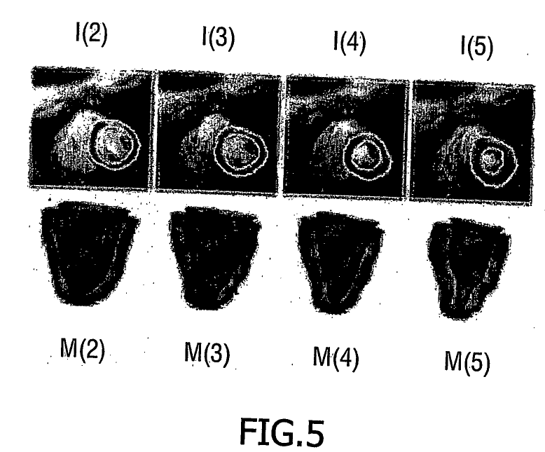

FIG. 5 shows a segmentation performed in accordance with an aspect of the present invention.

FIG. 1 shows a simplified schematic representation of an exemplary embodiment of an image processing device in accordance with the present invention. In FIG. 1 there is shown a central processing unit (CPU) or image processor 1 for adapting a deformable model surface to surfaces of an object of interest by mesh adaptation. The object may also be composed of multiple objects. In addition to being conceived to adapt a deformable model surface to the object surface, the image processing device depicted in FIG. 1 may also be adapted to determine or generate a surface model from one or a plurality of training models.

The image processor 1 is connected to a memory 1 for storing the images of time-series images, i.e. a plurality of images which have been successively taken from a moving or deforming object. The image processor 1 may be connected by a bus system 3 to a plurality of periphery devices or input/output devices which are not depicted in FIG. 1. For example, the image processor 1 may be connected to an MR device, a CT device, an ultrasonic scanner, to a plotter or a printer or the like via the bus system 3. Furthermore, the image processor 1 is connected to a display such as a computer screen 4 for outputting segmentation results. Furthermore, a keyboard 5 is provided, connected to the image processor 1, by which a user or operator may interact with the image processor 1 or may input data necessary or desired for the segmentation process.

FIG. 2 shows a simplified schematic diagram for explaining the generation of a surface model, which may be used in the method according to the present invention. In the following description, the present invention is described with reference to surface or shape models represented by triangular measures. However, it has to be noted that also simplex or polygonal meshes, or other suitable surface or shape models may be used.

Reference numeral 10 designates first time-series images, which were taken of a first training model. The images respectively represent snap-shots of the moving or deforming training object at a certain time difference. Reference numerals 12 and 14 designate further time-series images of further training models. Each of the time-series images 10, 12 and 14 consists of m 3D images I(t=0 . . . m−1), depicting the moving or deforming training object corresponding to the object of interest to be segmented later on at subsequent points in time t=0 . . . m−1.

Given N segmented time-series images I(t=0 . . . m−1), N * m triangular meshes may be derived in accordance with the method described in M. R. Kaus et al “Automated 3D PDM construction using deformable models” in 8^{th} International Conference on Computer Vision (ICCV), pages 566-572, Vancouver, Canada, 2001, IEEE Press, which is hereby incorporated by reference, such that for each segmented 3D image time-series, there is a set of m 3D triangular measures. Each mesh consists of V vertices with coordinates Vₖ, which are connected to W triangles. The topology of all measures is the same, i.e. V and W does not change.

According to an aspect of the present invention, a shape model M(t), which is a prior 3D+shape model may be derived by calculating the mean coordinates from all N meshes of a time-point t. Thus, shape models M(0) . . . M(m−1) may be generated for each image I(t=0 . . . m−1) of the time-series images 10, 12 and 14.

Thus, M(t) consists of a set of W triangles and V * m vertex coordinates, i.e. each mesh has the same topology, and the vertex coordinates depend on the time, i.e. vₖ(t) where
k=0−V−1 and t=0−m−1.

According to an aspect of the present invention, also additional information may be incorporated, such as, for example, an inter-individual variation of meshes at a particular time point t, using, for example, the principle component analysis as described by T. F. Cootes et al “A trainable method of parametric shape description” Image and Vision Comp., 10(5): 289-294,1992, which is hereby incorporated by reference. Instead of the principle component analysis, other suitable representations may also be used. For example, it is also possible to interpolate between the time-points t to derive the vertex coordinates vₖ(t) without an explicit mesh M(t), such as a mesh at time (t0+(t1−t0)/2).

FIGS. 3a and 3b show a flowchart of an exemplary embodiment of a method for operating, for example, the image processing device depicted in FIG. 1 in accordance with the present invention which may be implemented as computer program.

After the start in step S1, the method continues to step S2, where m time-series 3D images I(t) of a moving and/or deforming object of interest are acquired. In other words, a plurality of m images of a moving or deforming object of interest are read in, depicting the object of interest at subsequent points of time t. Then, in the subsequent step S3, a deformable model M(t) corresponding to the object of interest is read in. As mentioned above, the deformable model M(t) may have been determined as described with reference to FIG. 2. In the subsequent step S4, the first image I(0) of the time-series 3D images is loaded.

In step S5, following step S4, an initial mesh is adapted to the object in the image I(0). The adaptation of the initial mesh to the object of interest is performed on the basis of an energy optimization using the initial mesh and the shape model M(0) of the image I(0) to determine a first segmentation result S(0) of the object of interest in the image I (0).

This will now be described in further detail. After initial positioning of the initial mesh, the initial mesh is adapted to the object of interest by iteratively carrying out a surface detection for the object surface of the object of interest in the image for each triangle and a reconfiguration of the vertex coordinates by minimizing the energy E=Eₑₓₜ+α Eᵢₙₜ, wherein the parameter a weights a relative influence of the external energy Eₑₓₜ which drives the mesh towards detected surface points of the object of interest and the internal energy Eᵢₙₜ, which maintains the vertex configuration of the initial mesh, i.e. the form of the surface model M(0).

The surface detection is carried out for each triangle center xᵢ of the initial mesh. A point \tilde{x}ᵢ is determined along a normal nᵢ of the respective triangle which maximizes a cost function of a feature function F and a distance jδ to the triangle center according to
\tilde{x}ᵢ=xᵢ+δnᵢ arg max{F(xᵢ+j δnᵢ)−Dj²δ²}
where 21+1 is the number of points investigated, δ specifies the distance between two points on the profile, and D controls the tradeoff between feature strength and distance. A suitable feature function F may, for example, be taken from J. Weese et al “Shape constrained deformable models for 3D image segmentation” in proc. IPMI'01, pages 380-387, 2001, which is hereby incorporated by reference.

The external energy term drives the mesh towards the detected surface points:

$${E}_{ext} ( x ) = {\sum }_{i = 1}^{T} {{w}_{i} ( {\tilde{x}}_{i} - {x}_{i} )}^{2} , {w}_{i} = max \{ 0 , F ( {\tilde{x}}_{i} ) - {Dj}^{2} {δ}^{2} \} ,$$

with T being the number of triangles. The weights wᵢ give the most promising surface points \tilde{x}ᵢ with the largest influence during mesh reconfiguration.

The external energy maintains the distribution of the mesh vertex coordinates vⱼ, i.e. the edges of the initial mesh \tilde{v}ⱼₖ=\tilde{v}ⱼ−\tilde{v}ₖ

$${E}_{int} = {\sum }_{j 01}^{V} {\sum }_{k ∈ N ( j )} {( {v}_{j} - {v}_{k} - sR {\tilde{v}}_{jk} )}^{2} ,$$

where N(j) is the set of the neighbors of vertex j and V is the number of vertex coordinates. This is further described in J. Weese et al “Shape constrained deformable models for 3D medical image segmentation” in proc. IPMI'01, pages 380-387,2001, which is hereby incorporated by reference.

A rotation S and a scaling s of the mesh may be estimated for each iteration by using a fast closed-form point based registration method based on singular value decomposition. Since the energies Eₑₓₜ and Eᵢₙₜ are quadratic, an energy minimization results in an efficient solution of a sparse linear system using the conjugate gradient method. Then, after the adaptation of the initial mesh to the object of interest in the first image I (0) on the basis of a minimization of the external and internal energies, where the internal energy corresponds to distance between the segmentation result and the shape model and the external energy corresponds to distance between the object of interest and the segmentation result, the method continues to step S6, where a counter t is initialized with t=0. The initial mesh used in step S5 may be a mean mesh of the surface model M (0).

Then, in the subsequent step S7, the (t+1)th image I(t+1) of the time-series images is loaded. In other words, the subsequent image is loaded. Then, in the subsequent step S8, the segmentation result S(t) of the preceding image I(t) is applied to the image I(t+1) as the initial mesh. In other words, in case it is the first iteration with the counter t=0, the segmentation result S(0) of the first image I(0) is used as the initial mesh for the adaptation in the subsequent image I(1).

In the subsequent step S9, the initial mesh is adapted to the object of interest in the image S(t+1) by using S(t) as the initial mesh and the shape model M(t +1). As described with respect to step S5, the adaptation may be performed on the basis of an energy minimization with respect to the internal energy Eᵢₙₜ and the external energy Eₑₓₜ. The adaptation of the first mesh to the object of interest in the image I(t+1) may be performed in the same manner as described with respect to step S5, such that, for a further explanation of the energy minimization performed in step S9, it can be referred back to step S5. Then, when the energies have been minimized in step S9, i.e. a cut-off criterion for the minimization has been reached, the method continues to step S9, where it is determined whether the segmentation has been performed for all m images I(t) of the time-series 3D images. In case it is determined in step S9 that the segmentation has not been performed to all images of the time-series, the method continues to step S11, where the counter t is incremented t=t+1 and the method returns to step S9. Then, the segmentation is performed for the subsequent image by using the segmentation results of the preceding image as the initial mesh and by using the shape model of the respective actual image as described above.

In case it is determined in step S10 that the segmentation has been performed for each image of the time-series, as indicated by the encircled A at the bottom of FIG. 3a and the encircled A at the top of FIG. 3b, the method continues to step S12, where the segmentation results S(0) to S(t) are output, for example, to the computer screen 4. Then, the method continues to step S13, where it ends.

Hence, in accordance with an aspect of the present invention, for the segmentation of an object of interest in an image I(tᵢ) the surface model M(tᵢ) is used and the initial mesh for the segmentation process in the image I(tᵢ) is derived from the immediately preceding image I(tᵢ−1), which, as indicated above, may be the segmentation result S(tₑ−1). According to an aspect of the present invention, for the first image I(0), the mean mesh of the corresponding model M(0) may be used.

Advantageously, the method according to the present invention may allow to automatically model and segment structures that move and deform over time with an improved accuracy. The present invention provides an increased robustness of the segmentation process, in particular for 4D applications. Furthermore, advantageously, the method may allow to predict the next time step based on the model and the previous adaptation result.

The above described segmentation by deformable models may be used to derive geometric models for organs or bones from volumetric image data.

Such geometric models in the above described segmentation may be in particular advantageous for a variety of clinical applications. For example, an advantageous application area may be the 4D radio therapy planning, where organ boundary delineation is necessary for the determination of the optimal treatment parameters and to evaluate a dose distribution in 4D. Another advantageous field of application may be cardiac diagnosis, where geometric models of ventricles and the myocard of the heart may be required for perfusion, wall motion and ejection fraction analysis.

FIG. 4 shows a simplified drawing for further explaining an aspect of the present invention. As mentioned above, according to an exemplary embodiment of the present invention, a prior 4D shape model M(t) is combined with the adaptation results S(t−1) of the previous images. As may be taken from FIG. 4, the shape model M(0) is used for the segmentation of the object of interest in the image I(0). The segmentation results of this first segmentation is S(0). As mentioned above, as the initial mesh for the first image I(0), the mean mesh of the corresponding model M(0) may be used. Then, for the subsequent image I(1), the shape model M(1) is used and, as the initial shape for this second segmentation in the second image I(1), the segmentation result S(0) from the first segmentation is used.

Hence, for the final segmentation of the final image I(m−1) of the time-series of images, the shape model M(m−1) is used and the segmentation result S(m−2) of the subsequent segmentation as the initial mesh.

FIG. 5 shows the segmentation process in four subsequent images I(2) to I(5) (in the upper line of FIG. 5) and the corresponding shape models M(2) to M(5) (in the lower line of FIG. 5). As can be gathered from the Figures, for each actual image, the corresponding shape model M(t) is used, but, as the initial mesh, the segmentation result S(t−1) of the preceding image is used. Advantageously, this allows to perform an accurate segmentation of a moving or deforming object, even if the differences, i.e. the form or position differences, are large from one image to another.

1. Method of determining a first segmentation result of an object of interest in a first image of time-series images, the time-series images including the first image and a second image; the method comprising the step of: adapting an initial mesh to the object in the first image to determine the first segmentation result; wherein the adaptation of the initial mesh to the object of interest is performed on the basis of an energy optimisation using the initial mesh and a shape model of the first image; wherein the initial mesh corresponds to a second segmentation result of the object of interest in the second image; and wherein the second image precedes the first image in the time-series images.

2. The method of claim 1, wherein the energy optimisation further comprises the steps of: determining an internal energy corresponding to a first distance between the first segmentation result and the shape model; determining an external energy corresponding to a second distance between the object of interest and the first segmentation result; and minimizing the external and internal energies.

3. The method of claim 1, wherein the shape model is a time-dependent, three dimensional surface mesh determined from a training model.

4. The method of claim 1, wherein the object of interest is at least one of moving and deforming.

5. The method of claim 1, wherein the second image immediately precedes the first image in the time-series images.

6. The method of claim 1, wherein the method is a method for the automated segmentation in cardiac MRI.

7. Image processing device, comprising: a memory for storing a first and a second image of time-series images; and an image processor for adapting an initial mesh to an object of interest in the first image to determine a first segmentation result; wherein the adaptation of the initial mesh to the object of interest is performed on the basis of an energy optimisation using the initial mesh and a shape model of the first image; wherein the initial mesh corresponds to a second segmentation result of the object of interest in the second image; and wherein the second image precedes the first image in the time-series images.

8. Computer program for an image processing device for determining a first segmentation result an object of interest in a first image of time-series images, the time-series images including the first image and a second image, wherein a processor of the image processing device executes the following step when the computer program is executed on the processor: adapting an initial mesh to the object in the first image to determine the first segmentation result; wherein the adaptation of the initial mesh to the object of interest is performed on the basis of an energy optimisation using the initial mesh and a shape model of the first image; wherein the initial mesh corresponds to a second segmentation result of the object of interest in the second image; and wherein the second image precedes the first image in the time-series images.
